(19) United States
(12) Patent Application Publication
(10) Pub. No.: US 2019/0132660 A1
(43) Pub. Date: May 2, 2019

(54) SPEAKER TOWER WITH INDIVIDUAL SPEAKER ENCLOSURES

(71) Applicant: James White, Weems, VA (US)

(72) Inventor: James White, Weems, VA (US)

(21) Appl. No.: 16/170,977

(22) Filed: Oct. 25, 2018

Related U.S. Application Data
(60) Provisional application No. 62/578,401, filed on Oct. 28, 2017.

(51) Int. Cl. H04R 1/02

(52) U.S. Cl. CPC H04R 1/02

(57) ABSTRACT

A speaker enclosure comprising; a first enclosure, wherein said enclosure has a first opening on the first surface and a second opening on the third surface and the first and third surfaces are opposing each other, an extension member connected to the first enclosure, a second enclosure, wherein the second enclosure has a first opening on the first surface and is connected to the extension member on the second surface, a second extension member attached to the second enclosure, a third enclosure wherein the second extension member is attached to the second surface of the third enclosure and an opening is present on the first surface of the third enclosure, and at least three speakers, at least one speaker sized to fit the opening in the first enclosure, at least one speaker sized to fit the openings in the enclosures.

### CROSS-REFERENCE TO RELATED APPLICATIONS

This application is a continuation-in-part (and claims the benefit of priority under 35 USC 120) of U.S. application No. 62/578,401 filed Oct. 28, 2017. The disclosure of the prior applications is considered part of (and is incorporated by reference in) the disclosure of this application.

### BACKGROUND OF THE INVENTION

The present invention relates to a speaker tower, and more particularly to a speaker tower where each speaker is within its own enclosure.

Loudspeaker enclosures have one or more speakers mounted on them and are typically made of wood, wood composite or plastic. Besides mounting the speakers, enclosures help to prevent sound waves generated by the rearward-facing surface of the speaker driver from interfering with the sound waves generated by the forward-facing surface of the speaker driver. The forward- and rearward-generated sound waves are out of phase with each other because they are generated through opposite motion of the speaker diaphragm and because they travel different paths before converging at the listener's position. Interaction between the two waves can create distortions, echoes and reverberations.

Many loudspeaker enclosures use some sort of structure (usually a box) to contain the out-of-phase sound energy. Some enclosures are sealed, and the rearward-generated sound waves are contained in the enclosure and dissipated, stopping the rearward-generated sound waves from interfering with the forward-generated waves. An issue with these single body design containers is that the rearward generated sound wave and energy causes the container to move or shake negatively affect the forward generated sound of the other speakers. Additionally, the close proximity of the speakers in the container causes the sound generated by one speaker to interfere with the sound generated by another speaker.

It is an objective of the present invention to minimize or eliminate distortions, echoes and reverberations caused by out of phase sound wave distribution outside the tower and to reduce the movement and vibration of the speakers within the tower. It is a further objective to provide a true surround sound effect for realistic sound reproduction.

### SUMMARY

A speaker enclosure comprising; a first enclosure having a first surface, a second surface and a third surface, wherein said enclosure has a first opening on the first surface and a second opening on the third surface and the first and third surfaces are opposing each other, a first extension member connected to second surface of the first enclosure, a second enclosure having a first surface a second surface and a third surface, wherein the second enclosure has a first opening on the first surface and is connected to the extension member on the second surface, a second extension member attached to the third surface of the second enclosure, a third enclosure having a first surface and a second surface, wherein the second extension member is attached to the second surface of the third enclosure and an opening is present on the first surface of the third enclosure, and at least three speakers, at least one speaker sized to fit the opening in the first enclosure, at least one speaker sized to fit the opening in the second enclosure, and at least one speaker sized to fit the opening in the third enclosure.

### BRIEF DESCRIPTION OF THE DRAWINGS

FIG. 1 depicts an isometric view of a speaker, in accordance with one embodiment of the present invention.

FIG. 2 depicts an isometric view of the speaker from the rear, in accordance with one embodiment of the present invention.

FIG. 3 depicts a block diagram of an electrical system, in accordance with one embodiment of the present invention.

### DETAILED DESCRIPTION OF THE INVENTION

The present invention provides the advantage of separating each speaker in the tower to reduce the vibration and interference of the other speakers in the tower. Through the separation of the speakers, the insulation of the enclosures relative to one another, the direction or the speakers, and the distance between the speakers, the result is a speaker tower which produces audiophile quality in a simple and attractive form

As will be apparent to those of skill in the art upon reading this disclosure, each of the individual embodiments described and illustrated herein has discrete components and features which may be readily separated from or combined with the features of any of the other several embodiments without departing from the scope or spirit of the present invention. It is to be understood that this invention is not limited to particular embodiments described, as such may, of course, vary. It is also to be understood that the terminology used herein is for the purpose of describing particular embodiments only, and is not intended to be limiting, since the scope of the present invention will be limited only by the appended claims.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, the preferred methods and materials are now described.

All publications and patents cited in this specification are herein incorporated by reference as if each individual publication or patent were specifically and individually indicated to be incorporated by reference and are incorporated herein by reference to disclose and describe the methods and/or materials in connection with which the publications are cited. The citation of any publication is for its disclosure prior to the filing date and should not be construed as an admission that the present invention is not entitled to antedate such publication by virtue of prior invention. Further, the dates of publication provided may be different from the actual publication dates which may need to be independently confirmed.

It must be noted that as used herein and in the appended claims, the singular forms “a”, “an”, and “the” include plural referents unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements or use of a “negative” limitation.

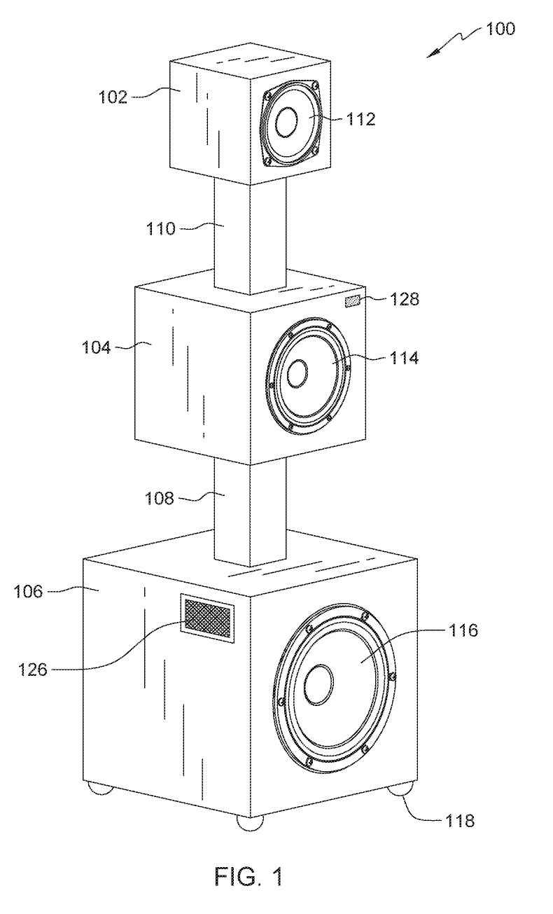

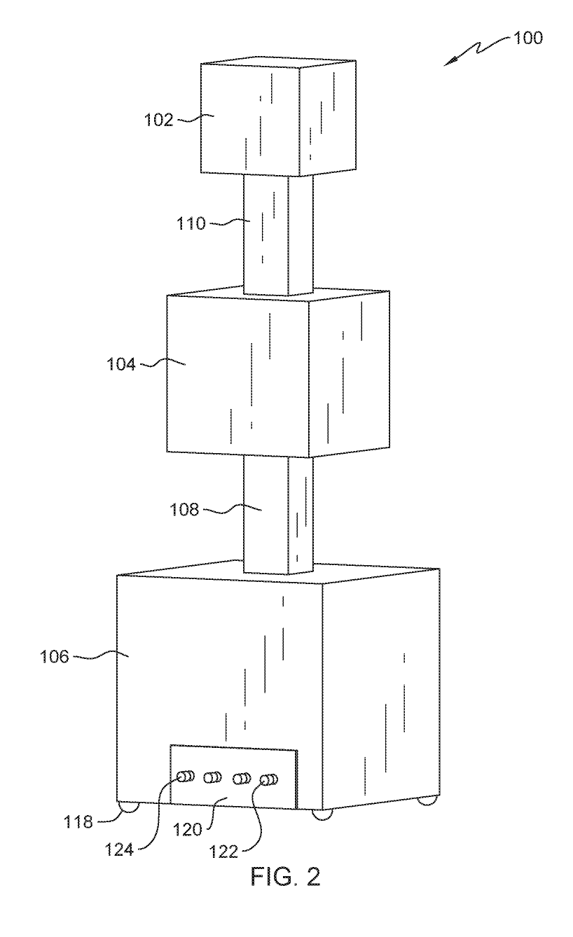

The speaker tower 100 can be constructed from the following components. As illustrated in FIGS. 1-2, a tower 100 is constructed. The tower 100 is comprised of a first enclosure 102, a second enclosure 104, a third enclosure 106, a first extension member 108 and a second extension member 110. Within the respective enclosures are a high frequency speaker 112 (e.g. tweeter), a medium frequency speaker 114, and a low frequency speaker 116 (e.g. sub-woofer).

The high frequency speaker 112 is configured to produce high-range sounds. The high-range sounds can be at least approximately 2,000 hertz, (2 Khz) and/or less than or equal to approximately 20 kilohertz (20 Khz). In some embodiments the high frequency speaker 112 can produce sounds that have frequencies lower than 2,000 hertz and/or higher than 20 kilohertz.

The medium frequency speaker 114 is configured to produce high-range sounds. The high-range sounds can be at least approximately 2000 hertz, (2 Khz) and/or less than or equal to approximately 250 hertz (0.25 Khz). In some embodiments the medium frequency speaker 114 can produce sounds that have frequencies lower than 250 hertz and/or higher than 2,000 hertz.

The low frequency speaker 114 is configured to produce high-range sounds. The low-range sounds can be at least approximately 100 hertz, (0.1 Khz) and/or less than or equal to approximately 20 hertz (0.02 Khz). In some embodiments the low frequency speaker 116 can produce sounds that have frequencies lower than 20 hertz and/or higher than 100 hertz.

In the depicted embodiment, the enclosures 104, 106, and 108 have a cubic shape and have an opening sized to fit the respective speaker. The enclosures may have varying shapes and sizes. In some embodiments, the enclosures may have more than one opening to allow for additional speakers. The enclosures can be made of medium density fiberboard (MDF). A plurality of different types of material can also be used, such as plastic, metal, composites, or wood. Preferably, the thickness of the material is at least approximately 20 millimeters and/or less than or equal to approximately 35 millimeters. However, the thickness of the material can be at least approximately 10 millimeters and/or less than or equal to approximately 40 millimeters. The external surface of the enclosure can have various colors, patterns, designed, covers, or material finishes to improve the aesthetic look of the tower 100.

In some embodiments, the enclosures have an insulation or coating placed within the enclosure to reduce the reward generated sound and energy. Various types of polyester fiberfill, adhesive (or non-adhesive) sound deadener matts or coatings, various acoustic foams, or the like.

Enclosure 106 can have feet 118. The feet can be made of a non-slip material, such as rubber, that help secure the tower 100 on surfaces, particularly slippery surfaces. The feet are preferably compliant and can absorb vibrations and reduce distortions of the speakers. There can be three or more feet pieces and can be in a variety of shapes and sizes.

The tower 100 can have screens (not shown) that are at least partially rigid to protect the speakers from dirt and damage. The screens can be a metallic mesh having small holes for sonic transparency and can be configured to cover the speaker portions of the enclosures. The screens can be held to the enclosures by a plurality of different methods, such as fasteners, clips, adhesives, or magnets. The screens, in some embodiments, cover the entire face of the enclosure.

The tower 100 can have a screen 126 that displays information, such as volume level, song information, battery level, clock, etc. The screen can be positioned on any of the enclosures 104, 106, 108, or the extensions, 110, and 112. In some embodiments, the screen can be a touch-screen that allows the user to select songs, change volume or otherwise input information to the tower 10.

The tower 100 can have a panel 128 one or more of a display and receiver. The panel can have an infrared (IR) receiver to receive signals from a hand-held remote control device to remotely adjust the volume, song selection, or other function. The panel may also have a light, such as a light emitting diode (LED) to indicate when the power to the tower 100 is on.

The tower 100 may have a panel 120 that can have inputs 122, outputs 124, and various connectors for various media devices. In additional embodiments, the tower 100 may have an adjustable volume control. The adjustable volume control may be a rotatable knob, a sliding adjuster, or up and down volume buttons. The tower 100 may also have an input connector, a sound input connector, a sound output connector and various other hardware plugs.

These hardware plugs are, for example, but not limited to, connectors in both digital and/or analog format such as HDMI®, RCA, 3.5 mm jacks, etc., or can be a proprietary connector type for the tower 100. For example, the hardware plugs can have a group of RCA connectors for accepting 5.1 or 7.1 channel sound sources. The RCA connectors can include a left front channel, center channel, right front channel, left rear channel, right rear channel, and subwoofer channel, providing the benefit of an audio crossover. In some embodiments, a proprietary connector can be employed to “daisy-chain” or connect multiple towers 100 together. In the illustrated embodiment of FIG. 4, the hardware plugs are shown on the rear surface of the enclosure 108. The hardware plugs can also be a ¼″ headphone output jack, two alternative 3.5 mm analog input & output jacks, or a digital USB type B jack for digital data streaming and firmware upgrades.

The extension members 108 and 110 are designed to separate and distance the enclosures 104, 106, and 108 a predetermined distance based on the speakers, so there is minimal interference between the sounds generated by each speaker. The extension members may have varying shapes and sizes. In some embodiments, the extension members are permanently affixed to the enclosures by a plurality of different methods. In additional embodiments, the extension members may have the ability to rotate with the integration of a rotation mechanism either between the connection between the extension member and the enclosure, or the extension member has an integration rotational mechanism. In some embodiments, the connection means between the extension member and the enclosures may be detachable to allow for variability of the length of the extension members. The extension members may be electrically and mechanically detachable from the enclosures to allow for the deconstruction and reconstruction of the speaker 100.

The extension members can be made of medium density fiberboard (MDF). A plurality of different types of material can also be used, such as plastic, metal, composites, or wood. Preferably, the thickness of the material is at least approximately 20 millimeters and/or less than or equal to approximately 35 millimeters. However, the thickness of the material can be at least approximately 10 millimeters and/or less than or equal to approximately 40 millimeters. The external surface of the enclosure can have various colors, patterns, designed, covers, or material finishes to improve the aesthetic look of the tower 100.

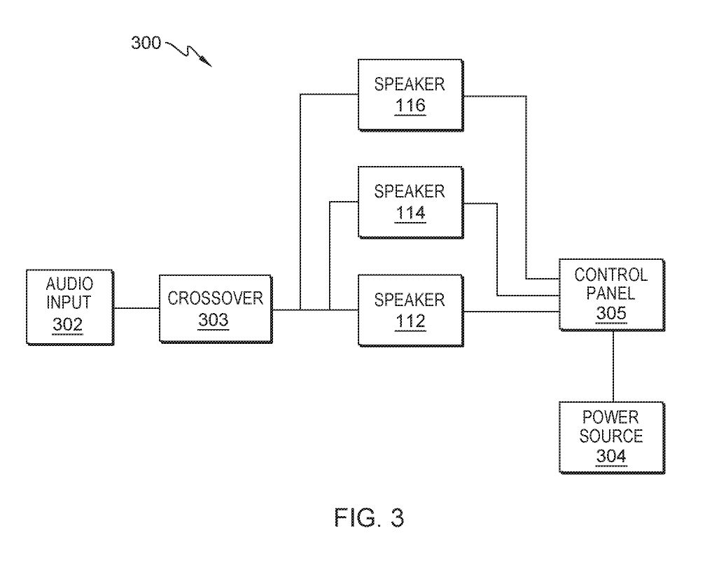

FIG. 3 depicts a block diagram of the electrical components of the window, in accordance with one embodiment of the present invention. In some embodiments, a computer circuit system 300 is integrated into the tower 100 to provide the separation of the audio into the three separate frequency via the crossover 300. As well as provide the power source 304, to provide ample power to the speakers 112, 114, and 116 as well as the panel 305 to control the speakers. In some embodiments additional elements such as amplifiers are incorporated into the system 300 where appropriate.

While this invention has been described in conjunction with the specific embodiments outlined above, it is evident that many alternatives, modifications and variations will be apparent to those skilled in the art. Accordingly, the preferred embodiments of the invention, as set forth above, are intended to be illustrative, not limiting. Various changes may be made without departing from the spirit and scope of this invention.

What is claimed is:

1. A speaker enclosure comprising:
a first enclosure having a first surface, a second surface and a third surface, wherein said enclosure has a first opening on the first surface and a second opening on the third surface and the first and third surfaces are opposing each other;
a first extension member connected to second surface of the first enclosure;
a second enclosure having a first surface a second surface and a third surface, wherein the second enclosure has a first opening on the first surface and is connected to the extension member on the second surface;
a second extension member attached to the third surface of the second enclosure;
a third enclosure having a first surface and a second surface, wherein the second extension member is attached to the second surface of the third enclosure and an opening is present on the first surface of the third enclosure; and
at least three speakers, at least one speaker sized to fit the opening in the first enclosure, at least one speaker sized to fit the opening in the second enclosure, and at least one speaker sized to fit the opening in the third enclosure.

2. The speaker enclosure of claim 1, wherein at least one hardware plug is exposed on the third surface of the first enclosure.

3. The speaker enclosure of claim 1, wherein the at least three speakers have mesh covers attached to the respective enclosures.

4. The speaker enclosure of claim 1, further comprising a cross-over system connected to the at least three speakers.

5. The speaker enclosure of claim 1, wherein the at least one speaker sized to fit the opening of the second enclosure is a medium frequency speaker.

6. The speaker enclosure of claim 1, wherein the at least one speaker sized to fit the opening of the third enclosure is a high frequency speaker.

7. The speaker enclosure of claim 1, further comprising a plurality of connectors, wherein the plurality of inputs comprises an audio input and audio output, and a power input.

8. The speaker enclosure of claim 7, wherein the audio input further comprises a crossover system.

9. The speaker enclosure of claim 1, further comprising, insulation material wherein the insulation material is placed within the first, second, and third enclosure.

10. The speaker enclosure of claim 1, further comprising a control panel, wherein the control panel has a plurality of inputs and a plurality of outputs.

11. The speaker enclosure of claim 1, further comprising a cross over electrically connected to the at least three speakers.

12. The speaker enclosure of claim 1, wherein the first and second extension members are electrically and mechanically detachable from the first, second, and third enclosures.

13. The speaker enclosure of claim 1, wherein the first and second extension members can rotate about the attachment means between the first, second, and third enclosures.

14. The speaker enclosure of claim 1, wherein one of the at least three speakers has a sound range between 2 Khz and 20 Khz.

15. The speaker enclosure of claim 1, wherein one of the at least three speakers has a sound range between 2 Khz and 0.25 Khz.

16. The speaker enclosure of claim 1, wherein one of the at least three speakers has a sound range between 0.25 Khz and 0.02 Khz.
